(19) United States
(12) Patent Application Publication
(10) Pub. No.: US 2008/0158237 A1
(43) Pub. Date: Jul. 3, 2008

(54) Graphics memory module

(76) Inventor: Pierre M. Selwan, Fremont, CA (US)

Correspondence Address: CAVEN & AGHEVLI;c/o INTELLEVATE, LLC, P.O. BOX 52050, MINNEAPOLIS, MN, 55402, US

(21) Appl. No.: 11/646,714

(22) Filed: Dec. 28, 2006

(51) Int. Cl. G06F 13/14

(52) U.S. Cl. 345/519

(57) ABSTRACT

Methods and apparatus relating to graphics memory modules are described. In an embodiment, a graphics logic is capable of accessing data stored in an external graphics memory module. Other embodiments are also described.

### BACKGROUND

The present disclosure generally relates to the field of electronics. More particularly, an embodiment of the invention relates to a graphics memory module.

Computer graphics performance has become and integral part of computer system performance. With rapidly evolving graphics workloads in support of visually rich applications, such as games or graphics-rich operating systems, graphics compute throughput and memory bandwidth requirements remain on a steep upward trend. One current solution utilizes a unified physical system memory for both graphics tasks and other processing tasks. Such an implementation may force improvements in graphics memory bandwidth to remain dependent on the development roadmap of general-purpose memory chips. Additionally, sharing of the system memory may result in a lower performance, for example, when several components may try to access the system memory simultaneously. Another current solution utilizes discrete graphics cards. Adding a graphics card may add a significant amount of cost, e.g., associated with the graphics card itself or other supporting components, such as a cooling fan or a power supply. Also, graphics cards generally include their own components, such as a graphics processor, which in turn add to heat generated in a system. The additional heat may damage IC chips present in the system by, for example, thermal expansion. Also, the additional heat may limit usage locations and/or applications of a computing device that includes a discrete graphics card.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1, 2, and 4 illustrate block diagrams of embodiments of computing systems, which may be utilized to implement various embodiments discussed herein.

FIG. 3 illustrates a flow diagram of a method in accordance with an embodiment of the invention.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

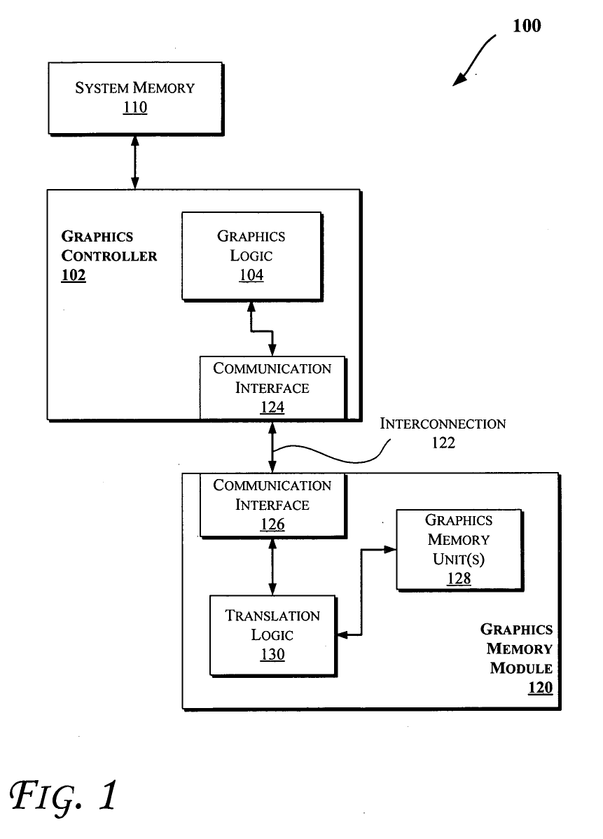

Some of the embodiments discussed herein may be utilized to improve memory bandwidth available to integrated graphics logic. In an embodiment, the graphics logic may be provided on an integrated circuit (IC) device. The graphics logic may have access to data stored in an external graphics memory module. Hence, the graphics logic may have access to memory bandwidth provided through the graphics memory module, in addition to or instead of access to a system memory that may be shared between various components of a computing system, such as the computing systems discussed with reference to FIG. 1, 2, or 4.

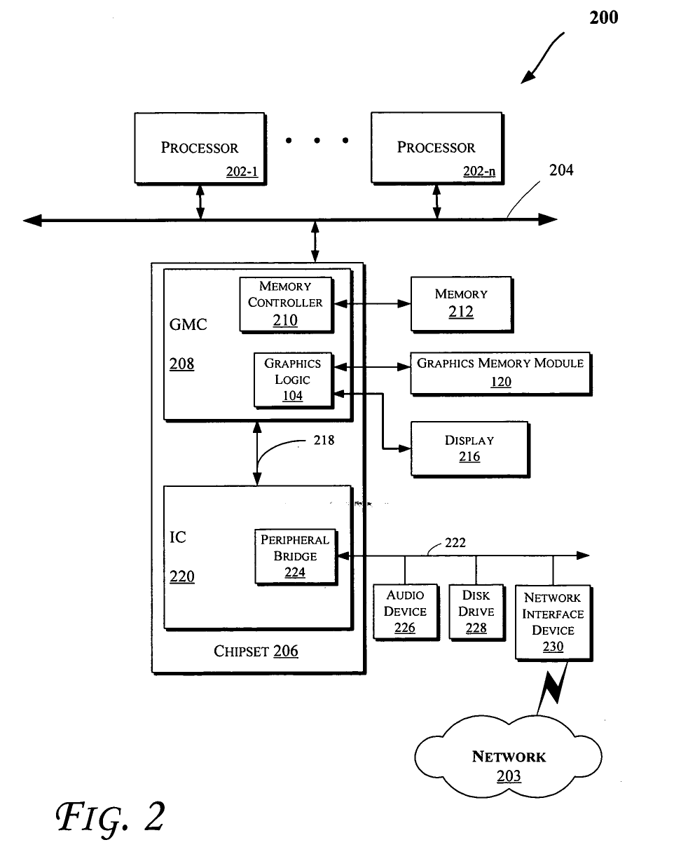

More particularly, FIG. 1 illustrates a block diagram of a computing system 100 in accordance with an embodiment of the invention. The computing system 100 may include a graphics controller 102 which may include a graphics logic 104 to access and/or process data stored in one or more of: a system memory 110 and/or one or more external graphics memory module(s) 120. In one embodiment, the graphics controller 102 may be provided on an IC device. In some embodiments, the IC device may be coupled to a motherboard of a computing device (such as a desktop computer, a portable computer, a personal digital assistance, a smart phone, etc.), for example, through a socket (such as a zero insertion force (ZIF) socket) and/or a soldered connection. In an embodiment, the system memory 110 may be accessible by other components of a computing system (such as one or more processor cores discussed with reference to FIG. 2). Moreover, the memory 110 may include bulk dynamic random access memory (DRAM) chips or units, which may simultaneously support two separate channels of double data rate (DDR) DRAM devices. Alternatively, additional channels of memory may be utilized to improve performance.

As shown in FIG. 1, an interconnection 122 may provide one or more communication channels between the graphics controller 102 (and hence the graphics logic 104) through communication interfaces 124 and 126. As discussed herein, the usage of “bus,” “interconnection,” or “interconnection network” may be interchangeable. Moreover, the interfaces 124 and 126 may communicate via various communication protocols such peripheral component interconnect (PCI) (e.g., which may comply with PCI Local Bus Specification, Revision 3.0, March 2004), PCI-X (e.g., which may comply with PCI-X Specification Rev. 2.0a, April 2003), or PCI express (PCIe) (e.g., which may operate in accordance with PCIe Specification, Revision 2.0, October 2006). In an embodiment, the communication interface 124 may be a PCIe graphics (PEG) port.

Additionally, the module 120 may include one or more graphics memory unit(s) 128 (generally referred to here as graphics “memory units” or more generally graphics “memory unit”), such as one or more units of graphics DDR (GDDR), DDR DRAM, etc. In some embodiments, the memory units used for the graphics memory module 120 may be faster (e.g., operating at a higher frequency), include less capacity, and/or provide a wider data path access when compared with the memory units used for the system memory 110. In an embodiment, graphics performance may be enhanced because the graphics logic 104 may have access to the graphics memory module through a dedicated interconnection or alternatively an interconnection which is shared amongst relatively less devices than the system memory 110. Also, the memory devices discussed herein (e.g., with respect to the system memory 110 and/or the memory module 120) may include various types of memory units in various embodiments, such as dual in-line memory modules (DIMMs) or small outline DIMMs (SO-DIMMs).

Furthermore, the system 100 may include a translation logic 130 to translate data communicated between the communication interfaces 124 and 126 between a first format (e.g., that may be used by the graphics logic 104) and a second format (e.g., that may be used by the graphics memory unit(s) 128). In some embodiments, the translation logic 130 may translate between proprietary low-level protocols, such as low level xDDR commands including a “pre-charge” command, an “open page” command, etc. Accordingly, the logic 130 may enable the graphics logic 104 to utilize any type of graphics memory unit(s) 128. Alternatively, the logic 130 may be located elsewhere in components of the system 100 (such as within the graphics controller 102) in some embodiments.

FIG. 2 illustrates a block diagram of a computing system 200 in accordance with an embodiment of the invention. The computing system 200 may include one or more central processing unit(s) (CPUs) 202 or processors that communicate via an interconnection network (or bus) 204. The processors 202 may include a general purpose processor, a network processor (that processes data communicated over a computer network 203), or other types of a processor (including a reduced instruction set computer (RISC) processor or a complex instruction set computer (CISC)). Moreover, the processors 202 may have a single or multiple core design. The processors 202 with a multiple core design may integrate different types of processor cores on the same integrated circuit (IC) die. Also, the processors 202 with a multiple core design may be implemented as symmetrical or asymmetrical multiprocessors. Further, the operations discussed with reference to FIG. 1, 3, or 4 may be performed by one or more components of the system 200.

A chipset 206 may also communicate with the interconnection network 204. The chipset 206 may include a graphics memory controller (GMC) 208. The GMC 208 may include a memory controller 210 that communicates with a memory 212 (which may be the same or similar to the memory 110 of FIG. 1). The memory 212 may store data, including sequences of instructions, that may be executed by the CPU 202, or any other device included in the computing system 200. In an embodiment, the memory 212 may be the same or similar to the memory 110 of FIG. 1. In one embodiment of the invention, the memory 212 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 204, such as multiple CPUs and/or multiple system memories.

The GMC 208 may also include the graphics logic 104 that communicates with a display device 216. In one embodiment of the invention, the graphics logic 104 may communicate with the display device 216 via an accelerated graphics port (AGP) and/or a PEG port. In an embodiment of the invention, the display 216 (such as a flat panel display) may communicate with the graphics logic 104 through, for example, a signal converter (not shown) that translates a digital representation of an image stored in a storage device such as video memory (e.g., the module 120) or system memory (e.g., memory 212) into display signals that are interpreted and displayed by the display 216. Moreover, in some embodiments that utilize a PEG port, one or more of the PEG port pins may be used to drive the display device 216 while one or more other pins of the PEG port may be used to access the graphics memory module 120. The display signals produced by the display device may pass through various devices before being interpreted by and subsequently displayed on the display 216.

An interface 218 may allow the GMC 208 and an input/output controller (IC) 220 to communicate. The IC 220 may provide an interface to I/O device(s) that communicate with the computing system 200. The IC 220 may communicate with a bus 222 through a peripheral bridge (or controller) 224, such as a peripheral component interconnect (PCI) bridge, a universal serial bus (USB) controller, or other types of peripheral bridges or controllers. The bridge 224 may provide a data path between the CPU 202 and peripheral devices. Other types of topologies may be utilized. Also, multiple buses may communicate with the IC 220, e.g., through multiple bridges or controllers. Moreover, other peripherals in communication with the IC 220 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 222 may communicate with an audio device 226, one or more disk drive(s) 228, and a network interface device 230 (which is in communication with the computer network 203). Other devices may communicate via the bus 222. Also, various components (such as the network interface device 230) may communicate with the GMC 208 in some embodiments of the invention. In addition, the processor 202 and the GMC 208 may be combined to form a single chip. Furthermore, a graphics accelerator may be included within the GMC 208 in other embodiments of the invention.

Furthermore, the computing system 200 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 228), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

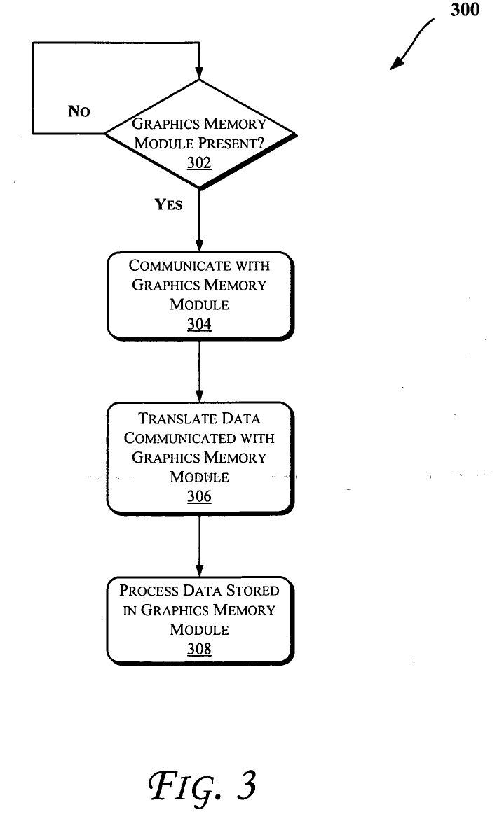

FIG. 3 illustrates a flow diagram of a method 300 to utilize a graphics memory module, according to an embodiment of the invention. In some embodiments, various components discussed with reference to FIGS. 1-2 and 4 may be utilized to perform one or more of the operations discussed with reference to FIG. 3.

Referring to FIGS. 1-3, at an operation 302, it is determined whether a graphics memory module is present in a computing system. For example, the graphics logic 104 may determine whether the graphics memory module 120 is present in a computing system (such as the computing systems of FIGS. 1-2 or 4). If the graphics memory module 120 is absent at operation 302, then the graphics logic 104 may process data stored in the system memory 110. In some embodiments, the presence of the graphics memory module(s) 120 may be determined by reference to a special hardware register, a transmitted message (e.g., with an indicia), a location with in a shared memory (such as an entry in the system memory 212), etc. At an operation 304, data may be communicated with the memory module of operation 302. For example, the graphics logic 104 may access (e.g., read or write) data in the graphics memory unit(s) 128, through the interfaces 124-126 and interconnection 122.

At an operation 306, data communicated with the memory module of operation 302 may be translated. For example, the logic 130 may translate the data as discussed with reference to FIG. 1. At an operation 308, data stored in the graphics memory module (e.g., the module 120 and/or system memory 110 (or memory 212)) may be processed (e.g., by the graphics logic 104).

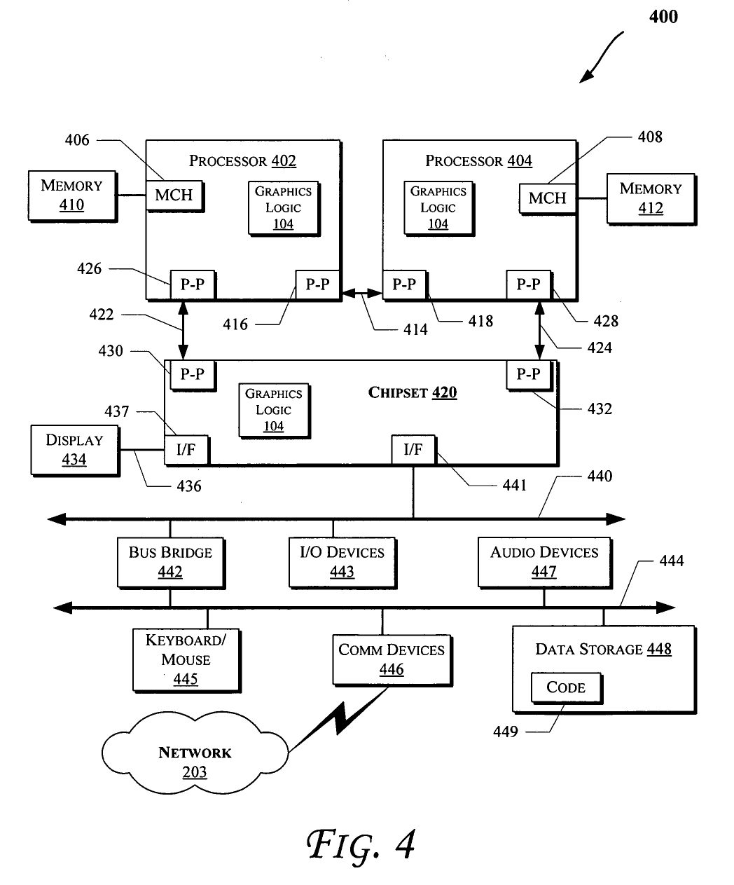

FIG. 4 illustrates a computing system 400 that is arranged in a point-to-point (PtP) configuration, according to an embodiment of the invention. In particular, FIG. 4 shows a system where processors, memory, and input/output devices are interconnected by a number of point-to-point interfaces. The operations discussed with reference to FIGS. 1-3 may be performed by one or more components of the system 400.

As illustrated in FIG. 4, the system 400 may include several processors, of which only two, processors 402 and 404 are shown for clarity. The processors 402 and 404 may each include a local memory controller (MC) 406 and 408 to enable communication with memories 410 and 412. The memories 410 and/or 412 may store various data such as those discussed with reference to the memory 212 of FIG. 2.

In an embodiment, the processors 402 and 404 may be one of the processors 202 discussed with reference to FIG. 2. The processors 402 and 404 may exchange data via a point-to-point (PtP) interface 414 using PtP interface circuits 416 and 418, respectively. Also, the processors 402 and 404 may each exchange data with a chipset 420 via individual PtP interfaces 422 and 424 using point-to-point interface circuits 426, 428, 430, and 432. The chipset 420 may further exchange data with a graphics circuit 434 via a graphics interface 436, e.g., using a PtP interface circuit 437.

At least one embodiment of the invention may be provided within the processors 402 and 404. For example, the graphics logic 104 of FIG. 1 may be located within one or more of the processors 402 and 404. Other embodiments of the invention, however, may exist in other circuits, logic units, or devices within the system 400 of FIG. 4. For example, the graphics logic 104 may be located within the chipset 420, in addition to or instead of one or more of the processors 402 and 404. Also, the graphics logics 104 may be in communication with one or more graphics memory modules (not shown, which may be the same or similar to the module 120 of FIGS. 1-2), e.g., via a point-to-point interface. Furthermore, other embodiments of the invention may be distributed throughout several circuits, logic units, or devices illustrated in FIG. 4.

The chipset 420 may communicate with a bus 440 using a PtP interface circuit 441. The bus 440 may communicate with one or more devices, such as a bus bridge 442 and I/O devices 443. Via a bus 444, the bus bridge 442 may communicate with other devices such as a keyboard/mouse 445, communication devices 446 (such as modems, network interface devices, or other communication devices that may communicate with the computer network 203), audio I/O device 447, and/or a data storage device 448. The data storage device 448 may store code 449 that may be executed by the processors 402 and/or 404.

In various embodiments of the invention, the operations discussed herein, e.g., with reference to FIGS. 1-4, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed with respect to FIGS. 1-4.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Reference in the specification to “one embodiment,” “an embodiment,” or “some embodiments” means that a particular feature, structure, or characteristic described in connection with the embodiment(s) may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An integrated circuit device comprising:
a graphics logic to access data stored in an external graphics memory module; and
a first communication interface to communicate the stored data between the graphics logic and the graphics memory module.

2. The device of claim 1, further comprising a memory controller to facilitate communication between the graphics logic and a system memory, wherein the system memory is to be shared between one or more components of a computing system.

3. The device of claim 1, wherein the graphics memory module is to comprise a translation logic to translate data communicated between the first communication interface and a second communication interface between a first format and a second format.

4. The device of claim 3, wherein the first communication interface communicates data with the second communication interface in accordance with a communication protocol.

5. The device of claim 4, wherein the communication protocol comprises one or more of a peripheral component interconnect (PCI) protocol, a PCI-X protocol, an accelerated graphics port (AGP) protocol, or a PCI express (PCIe) protocol.

6. The device of claim 3, wherein the graphics memory module comprises the second communication interface.

7. The device of claim 1, wherein a computing system comprises the graphics logic and a display device, wherein the display device is to display one or more images corresponding to the data stored in the graphics memory module.

8. The device of claim 1, wherein one or more of a socket or a soldered connection couple the integrated circuit device to a computing system motherboard.

9. A method comprising:
determining a presence of a graphics memory module; and
communicating data through a first communication interface with the graphics memory module in accordance with a communication protocol,
wherein the data is communicated with the graphics memory module after determining that the graphics memory module is present.

10. The method of claim 9, further comprising, a graphics logic, processing data stored in one or more memory units of the graphics memory module.

11. The method of claim 10, wherein the graphics memory module is coupled to an integrated circuit which comprises the graphics logic.

12. The method of claim 10, further comprising the graphics logic processing data stored in a system memory that is shared with one or more components of a computing system.

13. The method of claim 9, further comprising translating data communicated with the graphics memory module from a first format into a second format.

14. The method of claim 9, wherein the communication protocol comprises one or more of a PCI protocol, a PCI-X protocol, an AGP protocol, or a PCIe protocol.

15. The method of claim 9, wherein the graphics memory module receives the transmitted data through a second communication interface that communicates data in accordance with the communication protocol.
